(19) United States
(12) Patent Application Publication
(10) Pub. No.: US 2014/0215507 A1
(43) Pub. Date: Jul. 31, 2014

(54) PERSONALIZED PASSIVE CONTENT DELIVERY

(71) Applicants: Rita H. Wouhaybi, Portland, OR (US); Philip Muse, Folsom, CA (US); Mark D. Yarvis, Portland, OR (US); Sharad K. Garg, Portland, OR (US); James P. Melican, Hillsboro, OR (US)

(72) Inventors: Rita H. Wouhaybi, Portland, OR (US); Philip Muse, Folsom, CA (US); Mark D. Yarvis, Portland, OR (US); Sharad K. Garg, Portland, OR (US); James P. Melican, Hillsboro, OR (US)

(21) Appl. No.: 13/997,213

(22) PCT Filed: Dec. 8, 2011
(86) PCT No.: PCT/US11/63986

§ 371 Date: Jun. 22, 2013

(51) Int. Cl. H04N 21/466; H04N 21/472; H04N 21/482; H04N 21/24; H04N 21/81; H04N 21/442; H04N 21/258; H04N 21/2668; H04N 21/45

(52) U.S. Cl. CPC H04N 21/4667; H04N 21/2668; H04N 21/47202; H04N 21/4826; H04N 21/4532; H04N 21/812; H04N 21/44222; H04N 21/25891; H04N 21/2407
USPC 725/14

(57) ABSTRACT

Various embodiments are directed to a media processing device that can create a personalized passive viewing experience for a user. A personalization engine may determine viewer preferences based on multiple factors including past viewing behavior, web-browsing history, calendar event topics, and email data topics. The viewer preferences may then be formed into a user profile. A content aggregator component may then search multiple content sources for content compatible with the user profile. The content aggregator component may save found content or pointers to the content for later reference. The personalization engine may organize the saved content into a series of individual content items which may be presented on a display. Other embodiments are described and claimed.

### BACKGROUND

Content viewers on all platforms (TV, PC, mobile) face a staggering amount and variety of available content. Despite the diverse content availability, users watching television may prefer a passive viewing interaction. In a passive mode, content may be delivered in a serial manner in which a continuous serial content stream is delivered with advertisements sprinkled between items of content. Users may perceive a low effort entertainment model without having to search and select a next show to watch. Delivering a highly personalized content stream sourced from multiple content providers may enhance a user's viewing experience.

### BRIEF DESCRIPTION OF THE DRAWINGS

FIG. 1 illustrates one embodiment of a media processing system.

FIG. 2 illustrates one embodiment of a logic flow.

FIG. 3 illustrates one embodiment of a logic flow.

FIG. 4 illustrates one embodiment of a logic flow.

FIG. 5 illustrates one embodiment of a logic flow.

FIG. 6 illustrates one embodiment of a logic flow.

FIG. 7 illustrates one embodiment of a user interface display.

FIG. 8 illustrates an embodiment of a system that may be suitable for implementing embodiments of the disclosure.

FIG. 9 illustrates embodiments of a small form factor device in which the system of FIG. 8 may be embodied.

### DETAILED DESCRIPTION

Consumer electronics, processing systems and communications systems are converging. For instance, consumer electronics such as digital televisions and media centers are evolving to include processing capabilities typically found on a computer and communications capabilities typically found in mobile devices. As such, heterogeneous consumer electronics continue to evolve into a single integrated system, sometimes referred to as a “digital home system.”

A digital home system may be arranged to provide a compelling entertainment environment in which a user can move seamlessly between television viewing, internet access, and home media management in various embodiments. In some embodiments, a single flexible and dynamic interface may allow a user to find the television programming that they wish to view, acquire the information that they seek from the Web, or enjoy personal audio files, photos, and movies. A digital home system may provide these features while retaining the familiar design sensibilities and ease-of-use of a traditional television.

The digital home system may utilize, in some embodiments, a visual display such as a television display as a navigation device. Using the display in combination with any number of remote control devices, a user can carry out complex tasks in fulfilling and transformative ways. The digital home system may include familiar mechanisms such as on-screen programming guides, innovative technologies that facilitate navigation via natural motions and gestures and context-sensitivity that understands the user and the options available to the user which all combine to make the digital home system experience intuitive and efficient as it empowers the user to utilize multiple devices in a seamlessly integrated way.

The digital home system may include, in various embodiments, multi-axis integrated on-screen navigation allowing the display screen to be used for navigation as well as for the presentation of content. In some embodiments, the digital home system may also include a user interface operative to provide context-sensitive features and overlays intelligently integrated with the underlying content and adaptive to the viewing environment. A family of remote control and other input/output devices may also be incorporated into the digital home system in various embodiments to further enhance the intuitive user interactions, ease of use, and overall quality of the system. The embodiments are not limited in this context.

Various embodiments are directed to a media processing device that can create a personalized passive viewing experience for a user. A personalization engine may determine viewer preferences based on multiple factors including past viewing behavior, web-browsing history, calendar event topics, and email data topics. The viewer preferences may then be formed into a user profile. A content aggregator component may then search multiple content sources for content compatible with the user profile. The content aggregator component may save found content or pointers to the content for later reference. The personalization engine may organize the saved content into a series of individual content items which may be presented on a display.

The embodiments described herein disclose a cross-device media viewing experience that may provide a highly-personalized, continuous and passive stream of video content from multiple broadcast, streaming, and/or recorded/downloaded sources while affording the user full control over content selection, if desired. For example, the user may create a stream of hand-selected content or the user may enjoy a stream containing content that may be automatically selected based on preferences and restrictions they have set, or that may have been determined passively by filtering based on max run time, content rating/genre/topic/cast/crew and other meta-data.

Despite the growing content availability, users who are “watching TV” may prefer a passive viewing interaction. In this passive mode, content may be delivered in a serial manner. Unless the user takes action to seek different content, a continuous serial content stream may be delivered, often with advertisements periodically sprinkled within. Users perceive several benefits to this “TV viewing” model including low-effort entertainment, a social arbitrator for multiple viewers, and the ability to have background viewing without the mental overhead of choosing the next show. Without personalization, however, this model may result in undesirable content, boredom, and channel surfing.

Based on the above observations, a new model of content presentation that allows personalization, while preserving the passive viewing experience is disclosed. The embodiments may provide an approach that delivers one or more personalized content streams, each comprised of a series of individual content items sourced from one or more sources and/or providers such as, for instance, live broadcast (possibly time shifted), pre-recorded content, or streamed/VOD content. Content may be selected automatically by a personalization engine to fit a user's profile (e.g., interests, viewing patterns), the user's situational context (e.g., mood, available time), and the content available to the platform. Content may be presented automatically in the proposed ‘passive’ mode, or selected individually, browsed and searched, or selected from recommended or related content. While, by default, users may be presented with a personalized serial channel of content of interest to them, users may also be provided with opportunities to seek alternative content by scanning forward and backward in the personalized content stream and browse other recommended and related content.

Personalized content streams may be delivered by different devices to provide a consistent user experience. The user may pause playback on one device and resume at a later time on the same or different device inside or outside of home (similar to a feature available on some DVRs). In other cases, a user's experience of the personalized content stream on any single device could be significantly different based on changes in the context in which the device is being used. For example, while the user is at work, content presented on the user's device might include tutorials related to tasks that need to be done at work. However, once the user has returned home, the content may be very different and may be more geared for entertainment. In this example, the content preferences, and therefore the stream of personalized content presented to the user may be altered based on user's context.

Content delivery services (e.g., cable operators) may deliver as many or as few advertisements as desired to a given user, perhaps based on a payment model or the user's willingness to share viewing habits or other personal data. This may afford new models for the delivery and presentation of advertisements, new advertising revenue models, as well as new ways of personalizing the advertisements to the interests of the viewer(s).

One or more broadcast content tuners may be controlled to record specific content at specific times. Recorded content may be stored on a storage medium. Content may be played back (e.g., inserted into the personalized content stream) at any time after the start of recording, including during recording. A content aggregator component may receive input from the personalization engine, which determines what content to record and what content to play back. Content may be inserted into the content stream for delivery to a user interface component through the personalization engine.

A contextual understanding component may utilize several software and hardware sensors to observe a user and understand the user's interests and situational context. Contextual inputs may include the user's viewing behavior (e.g., what show or ad may be playing when the user chooses to fast forward, rewind, skip to the next show, etc.) which may be obtained from the user interface component. Physical sensors, such as cameras, microphones, motion sensors, and Bluetooth radios may help determine contextual factors such as a user's presence and mood. Sensors in mobile devices may track location over time, helping to identify user goals and interests. Software sensing in mobile and personal computer (PC) devices may intercept browsing, interpersonal communication, and calendar information. Over time the above inputs may help determine the user's interests, goals, and preferences. Viewing behavior, together with presence and mood may be analyzed by an inference algorithm to determine viewing patterns and viewing styles. Location traces, interpersonal communications, and browsing patterns may identify specific topics of interest to the user. These types of information may contribute to construction and continual updating of the user profile used by the personalization engine and content aggregator component to select content.

Location traces and mood inputs may help determine what content the user might be most receptive to at the moment. Calendar information may help determine how much time the user has for viewing content. These types of information about situational context may be delivered to the personalization engine to aid in selection of content.

The user profile may contain a persistent view of the user's interests, goals, and preferences. It may be updated by the contextual understanding component using contextual understanding inputs. It may also be shared with, and influenced by, other devices through a user profile cloud service. This cloud service may build an integrated view of the user profile using updates from multiple devices. This service may also store the content playback status allowing playback to be paused on one device and resumed on another.

The personalization engine's content aggregator component may be responsible for selecting the content using user preferences and contextual understanding. The content may be obtained from multiple content sources. The personalization engine may use information from the user profile, as well as situational context from the contextual understanding component to match available content to the user's interests, preferences, mood, available time, etc. The personalization engine also may use the user profile and future situational context together with programming information from an electronic program guide source to command one or more content sources to record relevant content for future viewing. The personalization engine may receive playback status from the user profile cloud service, allowing the user to resume playback on a given device after having paused on another device.

As advertisements and video content are integrated into a continuous personalized content stream, they are delivered to the user interface for display. In addition, an advertisement may be stored on the local storage of the device, and may be shown based on the user's location and context. For example, if the user is visiting a local home improvement store, then showing an advertisement for a tool may be more relevant. Another advantage of storing advertisements on local storage could be suitability to target device's form factor. For example, a 1080p advertisement may not be suitable or necessary to show on a smartphone. Between content, the personalization engine may drive a content selection screen. The personalization engine may also receive requests from the user interface to control video playback and to deliver and explicitly control user content selection. The personalization engine may also be responsible for delivering related content that may not necessarily be media. For example, the user might be presented with news articles related to a special s/he may be watching related to the actors, theme, era, show, etc.

The user interface component may provide the user interface used to render content on a display and take user input from a remote control or other input device. The user may use the remote control to fast forward and rewind through content, skip to the next show and interact to the content selection screen. The user interface component may report these user interactions with the contextual understanding component, reporting what content the user watches and how the user interacts with that content. The user interface may be provided on the main viewing device, perhaps when the user selects the menu button, or between individual content items. The user interface may also be provided on a secondary device. For example, if the main viewing device is a television, the user interface may be provided on a tablet. In this case, the tablet may act as a “contextual remote control” for the television.

As described above, by default the system plays a serial collection of shows that are automatically selected based on predicted user preference. This automatic selection of content may be based on many factors. The specific shows, genres, actors, etc preferred by a user may be determined by statistical analysis of the user's viewing patterns in relation to the contextual inputs which may include, but are not limited to, day of week, time of day, persons in the room, etc. Some users may prefer to watch an entire season's episodes of a particular show back to back, while others prefer the variety of viewing many different shows in a given sitting. Users' preferences for nostalgic viewing vary as well, ranging from heavy doses of their favorite oldies, to occasional oldies, to only fresh content. Some users must view new episodes of their favorite shows as soon as those episodes are broadcast, while others prefer to save new episodes for particular times of the day or week. Some users prefer to watch only their favorite shows, while others prefer to sample from shows they have never watched. These styles may be combined with a user's viewing patterns and may be factored into the selection of.

A content stream may be associated with a given user, but it may also be associated with a group of users. For example, the children in a household may have a distinct content stream from the adults. A given user may have a single content stream, or that user may have multiple content streams. In the latter case, each may be associated with a given personal interest or contextual situation (e.g., morning viewing vs. evening viewing vs. weekend viewing).

A user's personal interests (e.g., travel, fashion, home improvement, cooking, etc.) may be determined in a variety of ways. The system may simply observe what content the user watches to full length, skips, or explicitly selects for viewing. The user may fill out a survey. Or the user's personal devices may track his or her web browsing behavior, previous TV viewing or physical location to automatically identify interests. These interests may then be used by the personalization engine to select both content genres, as well as to identify special episodes of interest. The more the user uses the system, the more it will know about the user and customize its recommendations to better match the user's interests and personality. The amount of time the user has available to view content in a single session may be determined from the user's calendar or by the time of day and may determine whether the user prefers a half hour sitcom or a three-hour movie.

A given personalized content stream may contain advertisements. Advertisements may be customized in terms of the content of the advertisements, the number of advertisements, and the mood of the user, as well as the user's subscription terms and conditions. Advertisements may be placed in the beginning, middle, and/or end of an individual content item. In addition, the user may have the option of choosing when the advertisements appear in the personalized content stream. A user who allows his or her personal preferences to be used to select advertisements may be presented with fewer advertisements in exchange for providing advertisers with access to his or her personal preferences and be offered other incentives such as free premium movies. Similarly, users may receive fewer advertisements for sharing personal information with their cable provider or by paying a higher subscription fee.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

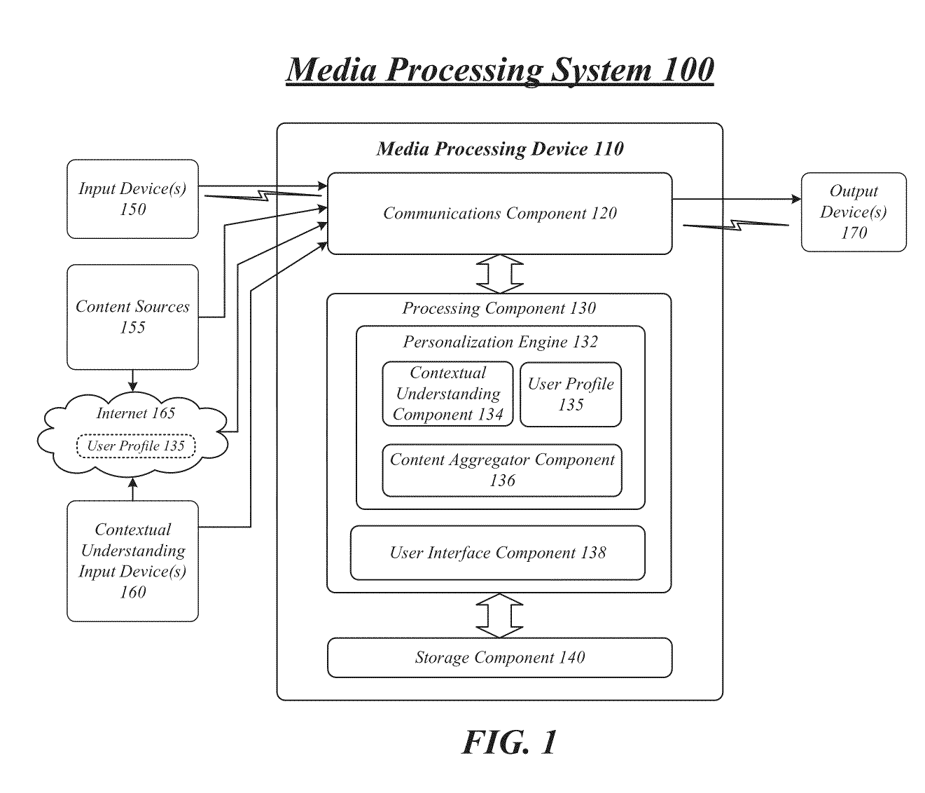

FIG. 1 illustrates a block diagram for a media processing system 100. The media processing system 100 is generally directed to performing media processing operations for media content in accordance with any associated control signaling necessary for presenting media content on an output device. In one embodiment, the media processing system 100 is particularly arranged to provide media content from disparate content sources to viewers in a home environment, such as a digital home system, for example. However, the media processing system 100 may be suitable for any use scenarios involving presentation and display of media content. Although the media processing system 100 shown in FIG. 1 has a limited number of elements in a certain topology, it may be appreciated that the media processing system 100 may include more or less elements in alternate topologies as desired for a given implementation. The embodiments are not limited in this context.

In various embodiments, various elements of the media processing system 100 may communicate, manage, or process information in accordance with one or more protocols. A protocol may comprise a set of predefined rules or instructions for managing communication among nodes. A protocol may be defined by one or more standards as promulgated by a standards organization, such as, the International Telecommunications Union (ITU), the International Organization for Standardization (ISO), the International Electrotechnical Commission (IEC), the Institute of Electrical and Electronics Engineers (IEEE), the Internet Engineering Task Force (IETF), the Motion Picture Experts Group (MPEG), and so forth. For example, the described embodiments may be arranged to operate in accordance with standards for media processing, such as the National Television Systems Committee (NTSC) standards, the Advanced Television Systems Committee (ATSC) standards, the Phase Alteration by Line (PAL) standards, the MPEG-1 standard, the MPEG-2 standard, the MPEG-4 standard, the Open Cable standard, the Society of Motion Picture and Television Engineers (SMPTE) Video-Codec (VC-1) standards, the ITU/IEC H.263 and H.264 standards, and others. Another example may include various Digital Video Broadcasting (DVB) standards, such as the Digital Video Broadcasting Terrestrial (DVB-T) broadcasting standard, the DVB Satellite (DVB-S) broadcasting standard, the DVB Cable (DVB-C) broadcasting standard, and others. Digital Video Broadcasting (DVB) is a suite of internationally accepted open standards for digital television. DVB standards are maintained by the DVB Project, an international industry consortium, and they are published by a Joint Technical Committee (JTC) of European Telecommunications Standards Institute (ETSI), European Committee for Electrotechnical Standardization (CENELEC) and European Broadcasting Union (EBU). The embodiments are not limited in this context.

In various embodiments, elements of the media processing system 100 may be arranged to communicate, manage or process different types of information, such as content and control information. Examples of content may generally include any data or signals representing multimedia content meant for a user, such as media content, voice information, video information, audio information, image information, textual information, numerical information, alphanumeric symbols, graphics, and so forth. Control information may refer to any data or signals representing commands, instructions, control directives or control words meant for an automated system. For example, control information may be used to route content through a system, to establish a connection between devices, instruct a device to process the content in a predetermined manner, monitor or communicate status, perform synchronization, and so forth. The embodiments are not limited in this context.

In various embodiments, media processing system 100 may be implemented as a wired communication system, a wireless communication system, or a combination of both. Although media processing system 100 may be illustrated using a particular communications media by way of example, it may be appreciated that the principles and techniques discussed herein may be implemented using any type of communication media and accompanying technology. The embodiments are not limited in this context.

When implemented as a wired system, for example, the media processing system 100 may include one or more elements arranged to communicate information over one or more wired communications media. Examples of wired communications media may include a wire, cable, printed circuit board (PCB), backplane, switch fabric, semiconductor material, twisted-pair wire, co-axial cable, fiber optics, and so forth. The wired communications media may be connected to a device using an input/output (I/O) adapter. The I/O adapter may be arranged to operate with any suitable technique for controlling information signals between elements using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

When implemented as a wireless system, for example, the media processing system 100 may include one or more wireless elements arranged to communicate information over one or more types of wireless communication media. An example of wireless communication media may include portions of a wireless spectrum, such as the RF spectrum. The wireless elements may include components and interfaces suitable for communicating information signals over the designated wireless spectrum, such as one or more antennas, wireless transmitters, receiver, transmitters/receivers (“transceivers”), amplifiers, filters, control logic, antennas, and so forth. The embodiments are not limited in this context.

In the illustrated embodiment shown in FIG. 1, the media processing system 100 may comprise a media processing device 110. The media processing device 110 may be communicatively coupled with one or more input devices 150, one or more output devices 170, one or more content sources 155, and a communications network such as the Internet 165. The media processing device 110 may be communicatively coupled to the input devices 150, the output devices 170, the content sources 155, and the Internet 165 via respective wireless or wired communications connections.

In various embodiments, the media processing system 100 may include one or more input devices 150. In general, each input device 150 may comprise any component or device capable of providing information to the media processing device 110. Examples of input devices 150 may include without limitation remote control devices, pointing devices, keyboards, keypads, trackballs, trackpads, touchscreens, joysticks, game controllers, sensors, biometric sensors, thermal sensors, motion sensors, directional sensors, microphones, microphone arrays, video cameras, video camera arrays, global positioning system devices, mobile computing devices, laptop computers, desktop computers, handheld computing devices, tablet computing devices, netbook computing devices, smart phones, cellular telephones, wearable computers, and so forth. The embodiments are not limited in this context.

In various embodiments, the media processing system 100 may include one or more output devices 170. An output device 170 may comprise any electronic device capable of reproducing, rendering or presenting media content for consumption by a human being. Examples of output devices 170 may include without limitation a display, an analog display, a digital display, a television display, audio speakers, headphones, a printing device, lighting systems, warning systems, mobile computing devices, laptop computers, desktop computers, handheld computing devices, tablet computing devices, netbook computing devices and so forth. The embodiments are not limited in this context.

While various embodiments refer to input devices 150 providing information to media processing device 110 and output devices 170 receiving information from media processing device, it should be understood that one or more of the input devices 150 and output device 170 may allow for the exchange of information to and from media processing device 110. For example, one or more of input devices 150 may be operative to provide information to media processing device 110 and to receive information from media processing device 110. In various embodiments, one or more of output devices 170 may be operative to receive information from media processing device 110 and may also be operative to provide information to media processing device 110. Similarly, there may be a bi-directional exchange between the media processing device 110 and content sources 155. For instance, a content source 155 may be operative to provide content to the media processing device 110 and to receive information from the media processing device 110. An example of this would be a video on demand (VOD) application implemented by the media processing device 110. The embodiments are not limited in this context.

In one embodiment, for example, an output device 170 may include a display. The display may comprise any analog or digital display capable of presenting content received from content sources 155. The display may display the content at a defined format resolution. In various embodiments, for example, the incoming video signals received from content sources 155 may have a native format, sometimes referred to as a visual resolution format. Examples of a visual resolution format include a digital television (DTV) format, high definition television (HDTV), progressive format, computer display formats, and so forth. For example, the content may be encoded with a vertical resolution format ranging between 480 visible lines per frame to 1080 visible lines per frame, and a horizontal resolution format ranging between 840 visible pixels per line to 1920 visible pixels per line. In one embodiment, for example, the content may be encoded in an HDTV video signal having a visual resolution format of 920 progressive (720p), which refers to 920 vertical pixels and 1280 horizontal pixels (720×1280). In another example, the content may have a visual resolution format corresponding to various computer display formats, such as a video graphics array (VGA) format resolution (640×480), an extended graphics array (XGA) format resolution (1024×968), a super XGA (SXGA) format resolution (1280×1024), an ultra XGA (UXGA) format resolution (1600×1200), and so forth. The embodiments are not limited in this context. The type of displays and format resolutions may vary in accordance with a given set of design or performance constraints, and the embodiments are not limited in this context.

In various embodiments, the media processing system 100 may include one or more content sources 155. Content sources 155 may comprise any content source capable of sourcing or delivering content and/or control information to media processing device 110. More particularly, content sources 155 may comprise any content source capable of sourcing or delivering digital audio and/or video (AV) signals to media processing device 110. Examples of content sources 155 may include any hardware or software element capable of storing and/or delivering content, such as a digital video recorder (DVR), a personal video recorder (PVR), a digital versatile disc (DVD) device, a video home system (VHS) device, a digital VHS device, a disk drive, a hard drive, an optical disc drive a universal serial bus (USB) flash drive, a memory card, a secure digital (SD) memory card, a mass storage device, a flash drive, a computer, a gaming console, a compact disc (CD) player, computer-readable or machine-readable memory, a digital camera, camcorder, video surveillance system, teleconferencing system, telephone system, medical and measuring instruments, scanner system, copier system, television system, digital television system, set top boxes, personal video recorders, server systems, computer systems, personal computer systems, smart phones, tablets, notebooks, handheld computers, wearable computers, portable media players (PMP), portable media recorders (PMR), digital audio devices (e.g., MP3 players), digital media servers and so forth. Other examples of content sources 155 may include media distribution systems to provide broadcast or streaming analog or digital AV signals to media processing device 110. Examples of media distribution systems may include, for example, Over The Air (OTA) broadcast systems, terrestrial cable systems (CATV), satellite broadcast systems, and so forth. It is worthy to note that content sources 155 may be internal or external to media processing device 110, depending upon a given implementation. The embodiments are not limited in this context.

In various embodiments, the media processing device 110 may comprise any electronic device arranged to receive, process, manage, and/or present content received from content sources 155. In general, the media processing device 110 may include, among other elements, a processing system, a processing sub-system, a processor, a computer, a device, an encoder, a decoder, a coder/decoder (codec), a filtering device (e.g., graphic scaling device, deblocking filtering device), a transformation device, a display, or any other processing or communications architecture. The embodiments are not limited in this context.

The media processing device 110 may execute processing operations or logic for the media processing system 100 using a processing component 130. The processing component 130 may comprise various hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The media processing device 110 may also include a communications component 120 and a storage component 140. Via the media processing device 110 communications component 120, a personalization engine 132, a contextual understanding component 134, a content aggregator component, and a user interface component 138 may be communicatively coupled to the Internet 165. The media processing device 110 may be able to send and/or receive content over the Internet 165.

The media processing device 110 may execute communications operations or logic for the media processing system 100 using communications component 120. The communications component 120 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 120 may include various types of standard communication elements, such as one or more communications interfaces, network interfaces, network interface cards (NIC), radios, wireless transmitters/receivers (transceivers), wired and/or wireless communication media, infra-red transceivers, serial interfaces, parallel interfaces, bus interfaces, physical connectors, and so forth.

In one embodiment, the processing component 130 may implement a personalization engine 132. The personalization engine 132 may perform operations pertaining to determining viewing preferences associated with a human user to create a user profile 135. The personalization engine 132 may include and direct the contextual understanding component 134 and the content aggregator component 138. The embodiments are not limited in this context.

In one embodiment, the processing component 130 may implement a contextual understanding component 134. The contextual understanding component 134 may perform operations pertaining to gathering information pertaining to the human user's viewing preferences. This may entail receiving input from a variety of external devices denoted as contextual understanding input device(s) 160. The contextual understanding input device(s) 160 may be communicable with the contextual understanding component 134 via the communication component 120 and processor component 130. Examples of contextual understanding input device(s) 160 may include a human user's computer which may be able to supply data representing topics of interest to the user. For instance, the web-browsing history and bookmarks may indicate topics of interest to the user. The user's email data may be mined to determine additional topics of interest to the user. Calendar events may also be mined. For instance, a concert for a band may be on the user's calendar which may indicate a type of music preferred by the user. The user's prior viewing history and habits may also be input to the contextual understanding component 134. Once there is sufficient input to the contextual understanding component 134, a user profile 135 may be generated. The user profile may include broad and specific preferences or interests associated with the user. The embodiments are not limited in this context.

In one embodiment, the processing component 130 may implement a content aggregator component 136. The content aggregator component 136 may use the user profile 135 generated by the contextual understanding component 134 as input for a search engine type function that searches the multiple content sources 155 for content of interest that the user may enjoy. For instance, the content aggregator component 136 may search channel guides for content sources 155 like a cable TV or satellite TV provider. The content aggregator component 136 may also utilize search functions on web-sites that provide streaming video content such as, but not limited to, Netflix™ or Hulu™. The content aggregator component 136 may also search any locally connected devices like a separate digital video recorder (DVR) or the like for stored content that may be of interest to the user. The content aggregator may also search the user's other consumer electronic or personal computing devices via a local area network to find available content. Protocols such as hypertext transfer protocol (HTTP), file transfer protocol (FTP), network file system (NFS), distributed file system (DFS), server message block (SMB), digital living network alliance (DLNA) and other file sharing or streaming protocols may be used in this respect. The embodiments are not limited in this context.

The personalization engine 132 may also retrieve and store content of interest to the user. The personalization engine 132 may then organize the content data into a series of individual content items that form a personalized content stream for the user. Moreover, the personalization engine 132 may also search for and receive advertising content personalized for the user. The advertising content may be inserted into the personalized content stream between individual content items. The embodiments are not limited in this context.

In one embodiment, the processing component 130 may implement a user interface component 138. The user interface component 138 may perform operations controlling the presentation and display of the personalized content stream on a display device. The user interface component 138 may also control access to the personalized content via an input device 150 such as a remote control. The user may have the option of passively watching or actively interacting with the personalized content stream. The user interface component 138 may present a user interface window or screen (see, FIG. 7 below) that is navigable by the user via the remote control or other input device 150. The user interface component 138 may also allow the user to skip ahead or back along the personalized content stream to select a different individual content item. The user interface component 138 may also allow the user to pause or stop viewing a particular individual content item at any point. The point at which the individual content item was paused or stopped may be saved so that the user may resume watching that individual content item at the point it was paused or stopped. The embodiments are not limited in this context.

In one embodiment, the processing component 130 may implement a storage component 140. The storage component 140 may store actual content data downloaded from one or more content sources 155. The storage component 140 may also store location information pertaining to actual content such that the content may be found and presented at the time of viewing. The storage component 140 may also store the user profile 135. The embodiments are not limited in this context.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

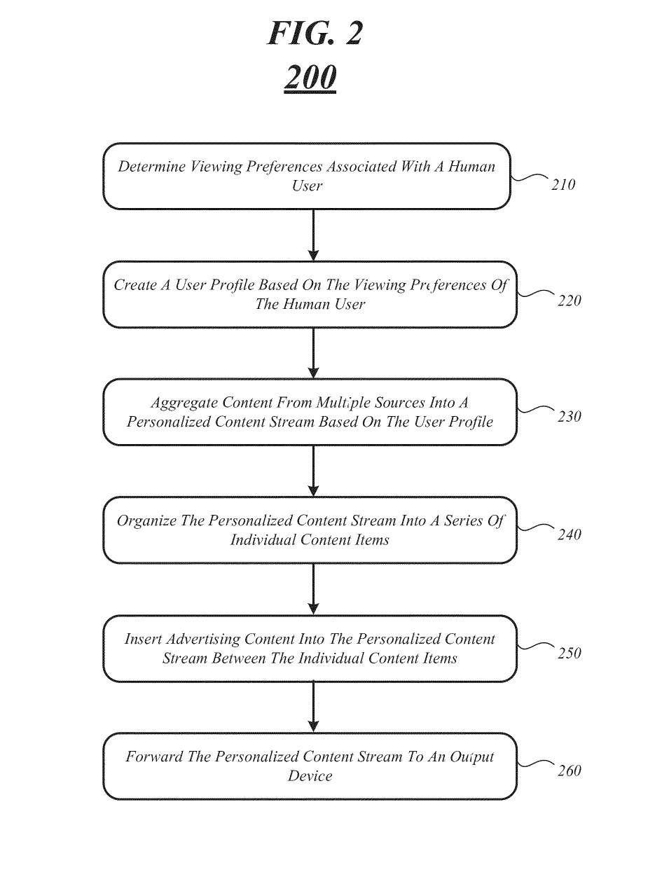

FIG. 2 illustrates one embodiment of a logic flow 200 in which a viewer is presented with a personalized content stream of individual content items. The personalized content stream may then be presented on a display to the user in effect creating a “channel” personalized to the user's preferences. The logic flow 200 may be representative of some or all of the operations executed by one or more embodiments described herein. The term individual content item may represent broadcast audio/video content such as a television program associated with a particular channel or network that is airing at a particular time. The term individual content item may also represent other forms of audio/video data that can be delivered to a display such as, for instance, streaming video received from the Internet or other packet data network. The term individual content item may also represent audio/video data stored in a file. The audio/video data may be represented in many formats.

In the illustrated embodiment shown in FIG. 2, a contextual understanding component 134 within the personalization engine 132 operative on a processing component 130 may determine viewing preferences associated with a human user at block 210. For example, the contextual understanding component 134 may collect or receive input data pertaining to a human user. The input data may pertain to topics of interest to the human user. The embodiments are not limited to this example.

In the illustrated embodiment shown in FIG. 2, the contextual understanding component 134 operative on the processing component 130 may create a user profile 135 based on the viewing preferences of the human user at block 220. For example, the data collected at block 210 above may be processed to determine various topics of interest to the human user. The data may also be processed to determine other contextual or situational information about the human user such as, for instance, locations visited, time of day, mood, musical preferences, etc. The embodiments are not limited to this example.

In the illustrated embodiment shown in FIG. 2, a content aggregator component 136 operative on the processing component 130 may use the user profile 135 to aggregate content from multiple content sources 155 at block 230. For example, the content aggregator component 136 may take elements of the user profile and perform a search of known content sources 155 to find individual content items that may be of interest to the human user. The embodiments are not limited to this example.

In the illustrated embodiment shown in FIG. 2, the personalization engine 132 operative on the processing component 130 may select content aggregated by the content aggregator component 136 based on the user profile 135 at block 240. For example, the personalization engine 132 may assemble the content discovered by the content aggregator component 136 into one or more serial stream of individual content items (e.g., personalized content streams). The personalized content streams may be based on specific genres, the time of day, the mood of the user, etc.

The individual content items may be broadcast television shows, streamed or streaming video from a content source 155 on the Internet 165, or files stored in the storage component 140. Some examples of web-site content sources include YouTube™, Netflix™, and Hulu™. The personalization engine 132 may choose content that it decides the user may want to watch based on the user profile 135. The embodiments are not limited to these examples.

In the illustrated embodiment shown in FIG. 2, the personalization engine 132 operative on the processing component 130 may insert advertising content into the personalized content stream between or within individual content items at block 250. For example, the personalization engine 132 may use the user profile 135 to find or receive targeted advertisements. The targeted advertisements may then be inserted into the personalized content stream between or within individual content items. The length and frequency of the advertisements may be determined based on a variety of factors previously described. The embodiments are not limited to this example.

In the illustrated embodiment shown in FIG. 2, a user interface component 138 operative on the processing component 130 may forward the personalized content stream to an output device at block 260. For example, the user interface component 138 may serve as the interface between the human user and the personalized content stream. The user interface component 138 may control the display of the content itself as well as the interface for accessing the content according to a user interface screen shown in FIG. 7 below. The embodiments are not limited to this example.

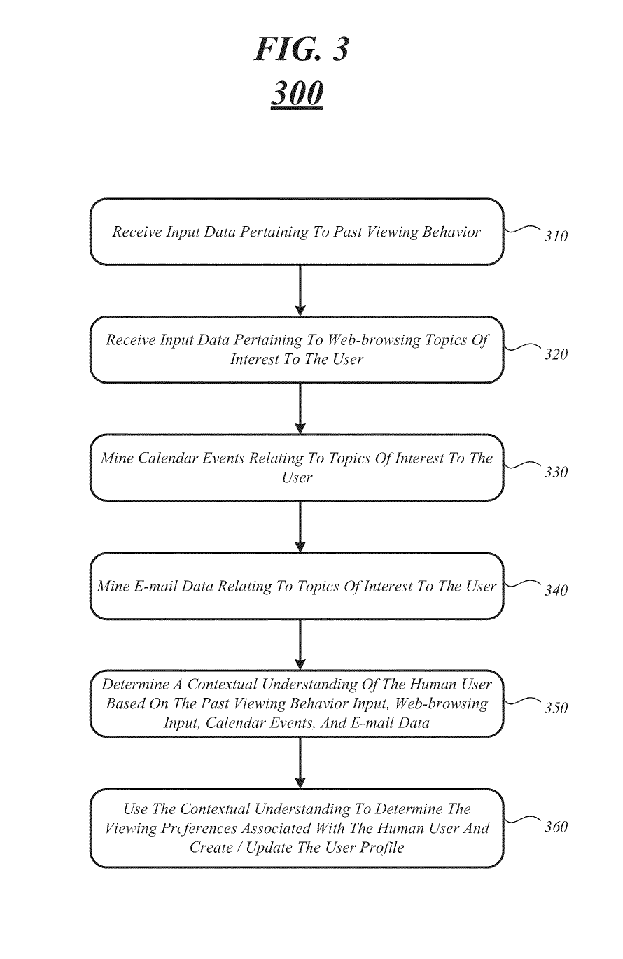

FIG. 3 illustrates one embodiment of a logic flow 300 further describing the steps associated with block 210 of FIG. 2 above. In each of the data gathering steps described below, the media processing device 110 implementing the processing component 130, personalization engine 132, contextual understanding component 134, content aggregator component 136 and user interface component 138 may have access to and the ability to exchange information with one or more contextual understanding devices 160. The contextual understanding devices 160 may include personal computers (PCs), mobile computers, laptop computers, computer enabled smartphones, tablet computers, and a variety of localized sensor devices. Each of the contextual understanding devices 160 may be capable of gathering and forwarding information pertaining to the human user to the contextual understanding component 134. The logic flow 300 may be representative of some or all of the operations executed by one or more embodiments described herein.

In the illustrated embodiment shown in FIG. 3, the contextual understanding component 134 operative on the processing component 130 may receive input data pertaining to past viewing behavior at block 310. For example, the contextual understanding component 134 may collect or receive input data pertaining to the viewing history of the human user. The user interface component 138 may send a signal indicative of the individual content items viewed by the human user. In addition, the user interface component 138 may also send signals indicative of how the human user interacted with the individual content item. This may include any fast forward, rewind, skip or other navigational interactions the user may have had with the individual content item. The embodiments are not limited to this example.

In the illustrated embodiment shown in FIG. 3, the contextual understanding component 134 operative on the processing component 130 may receive input data pertaining to web-browsing topics of interest at block 320. For example, the contextual understanding component 134 may collect or receive input data pertaining to the human user's web-browsing history and bookmarks. The web-browsing history may provide information pertaining to general and specific topics of interest to the user. For instance, the human user may search for and/or navigate to an Internet to a web-site associated with the Philadelphia Phillies baseball team. This information may be stored by the contextual understanding component 134 such that the content aggregator component 136 may search for content pertaining to the Philadelphia Phillies. The embodiments are not limited to this example.

In the illustrated embodiment shown in FIG. 3, the contextual understanding component 134 operative on the processing component 130 may receive input data pertaining to calendar events at block 330. For example, the contextual understanding component 134 may mine the human user's computer calendar software to collect or receive input data pertaining to past and future calendar events. The calendar events may be indicative of topics of interest to the human user. For instance, the human user may have a calendar event titled “Guitar Sale”. This event may be indicative of an interest in guitars that may be stored by the contextual understanding component 134. Similarly, calendar events indicative of travel may be stored by the contextual understanding component 134 to help refine advertising content based on expected user location. The calendar events may also be indicative of time available for content viewing. For example, if the user has an early meeting scheduled for the next day, they may be less likely to have interest in starting to watch a long movie late in the evening. The embodiments are not limited to these examples.

In the illustrated embodiment shown in FIG. 3, the contextual understanding component 134 operative on the processing component 130 may receive input data pertaining to email data at block 340. For example, the contextual understanding component 134 may collect or receive input data pertaining to emails sent and received by the human user. For instance, the human user may have an email thread with a friend discussing the wine that was served at a party recently. This email exchange may be indicative of an interest in wine that may be stored by the contextual understanding component 134. The embodiments are not limited to this example.

In the illustrated embodiment shown in FIG. 3, the contextual understanding component 134 operative on the processing component 130 may r process the data determined and stored at blocks 310-340 to determine a contextual understanding of the human user at block 350. The contextual understanding component 134 may then use the contextual understanding of the human user to determine the viewing preferences associated with the human user at block 360. This information may then be used to create and or update the user profile 135. The embodiments are not limited to this example.

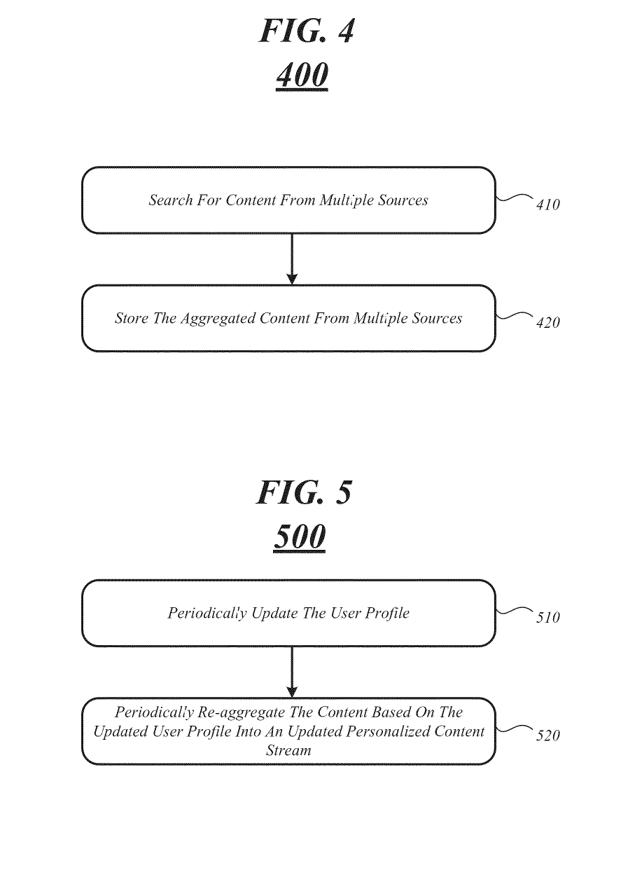

FIG. 4 illustrates one embodiment of a logic flow 400 further describing the steps associated with block 230 of FIG. 2 above. The logic flow 400 may be representative of some or all of the operations executed by one or more embodiments described herein.

In the illustrated embodiment shown in FIG. 4, the content aggregator component 136 operative on the processing component 130 may search for content from multiple content sources 155 at block 410. For example, the content aggregator component 136 may use the data in the user profile 135 to perform multiple searches for content that may be aligned with the human user's viewing preferences. This may include searching the program guide of a broadcast TV, cable TV, or satellite TV provider, searching the offerings of a streaming content provider such as YouTube™, Netflix™, or Hulu™, or searching localized content sources 155 like attached storage or other devices available via a local area network (LAN). The embodiments are not limited to this example.

In the illustrated embodiment shown in FIG. 4, the content aggregator component 136 operative on the processing component 130 may store the aggregated content from the multiple content sources 155 at block 420. For example, the content aggregator component 136 may obtain some or all of the actual content that was discovered by the search performed at block 410. Alternatively, the content aggregator component 136 may determine the location of the content. The content aggregator component 136 may then store the content or the location of the content in the storage component 140. In the case of broadcast television, the content aggregator component 136 may use a tuner to record the content at the appropriate time and store it in the storage component 140. The embodiments are not limited to this example.

FIG. 5 illustrates one embodiment of a logic flow 500 further describing the steps associated with updating the user profile 135. The logic flow 500 may be representative of some or all of the operations executed by one or more embodiments described herein.

In the illustrated embodiment shown in FIG. 5, the personalization engine 132 operative on the processing component 130 may periodically update the user profile 135 at block 510. For example, the personalization engine 132 may control the contextual understanding component 134 to periodically repeat the process of determining the human user's viewing preferences. This may entail gathering more information about the user as described in FIG. 3 above. The additional information may supplement the existing information to create a more refined user profile 135 because there is more data with which to determine the human user's viewing preferences. The embodiments are not limited to this example.

In the illustrated embodiment shown in FIG. 5, the content aggregator component 136 operative on the processing component 130 may periodically re-aggregate content based on the update user profile 135 at block 510. For example, the personalization engine 132 may direct the content aggregator component 136 to re-perform the steps described in FIG. 4 above to obtain additional content. The content aggregator component 136 may then update the personalized content stream(s) using any new content discovered based on the updated user profile 135. The embodiments are not limited to this example.

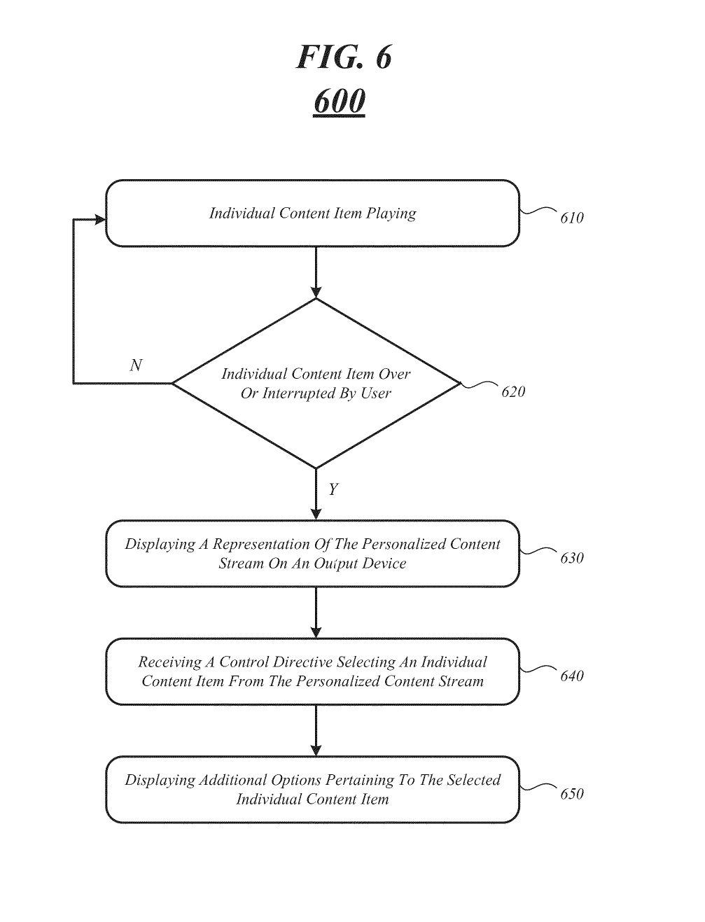

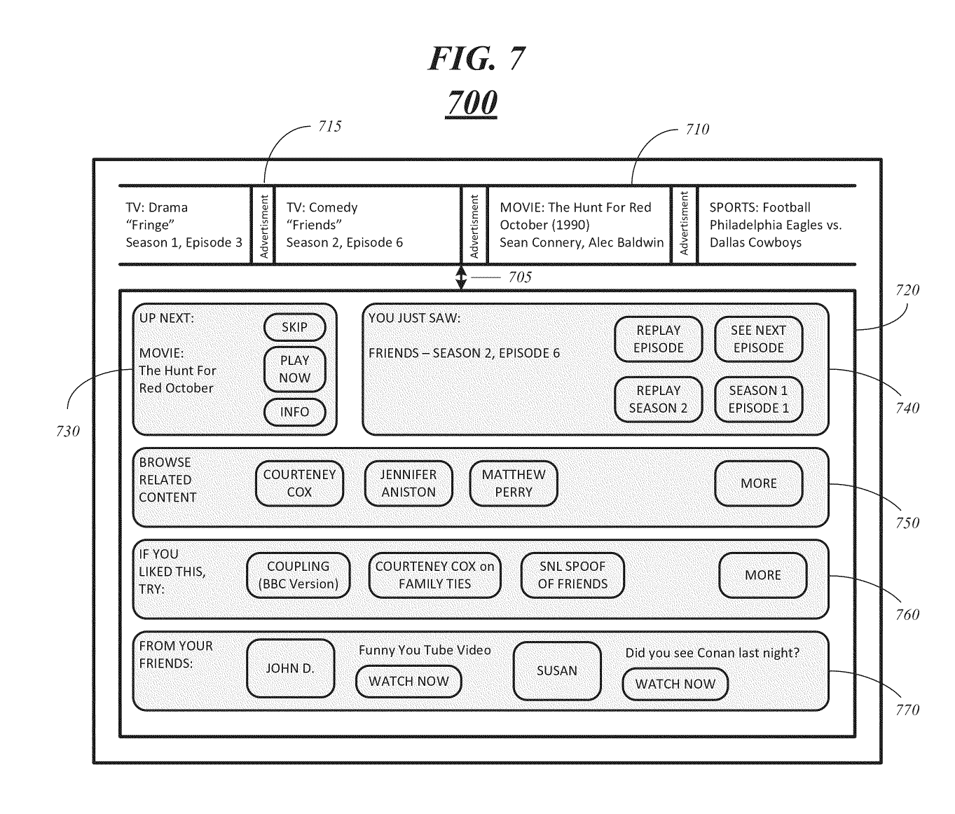

FIG. 6 illustrates one embodiment of a logic flow 600 further describing the steps associated with presenting the personalized content stream on an output device 170 such as a television display. The logic flow 600 may be representative of some or all of the operations executed by one or more embodiments described herein.

In the illustrated embodiment shown in FIG. 6, an individual content item may be playing at block 610. For example, an output device may be playing a previously selected individual content item based on the personalized content stream. The embodiments are not limited to this example.

In the illustrated embodiment shown in FIG. 6, it may be determined whether an individual content item playing has ended or has been interrupted by the user at block 620. For example, an individual content item may have ended and, after a short timeout period, may proceed to the next step. In addition, the user may choose to interrupt the current content item. The embodiments are not limited to this example.

In the illustrated embodiment shown in FIG. 6, the user interface component 138 operative on the processing component 130 may display a representation of the personalized content stream on an output device 170 at block 630. For example, the user interface component 138 may display a user interface screen like that depicted in FIG. 7 below on a display. The embodiments are not limited to this example.

In the illustrated embodiment shown in FIG. 6, the user interface component 138 operative on the processing component 130 may receive a control directive selecting an individual content item from the representation of the personalized content stream at block 640. For example, the user interface component 138 may display the user interface screen such that the human user may select an individual content item to view or to obtain more information about that individual content item. The default view for the user interface screen may be to consider the current individual content item as the selected item until the human user makes a different selection. The embodiments are not limited to this example.

In the illustrated embodiment shown in FIG. 6, the user interface component 138 operative on the processing component 130 may display additional options pertaining to the selected individual content item at block 650. For example, the user interface component 138 may include a section that may assist the human user in navigating about the personalized content stream. The embodiments are not limited to this example.

FIG. 7 illustrates one embodiment of a user interface screen 700 according to one embodiment. The user interface screen 700 may include a horizontal banner across the top portion of the user interface screen 700. The horizontal banner may be indicative of a personalized content stream 710. In this example, arrow 705 indicates where the human user is in the personalized content stream 710. On the top point of arrow 705 may be the personalized content stream 710 showing past individual content items to the left and future individual content items to the right. Also shown in the personalized content stream 710 are periodic advertisements 715 that are positioned between individual content items. The advertisements 715 may play on the display in between the individual content items. The human user may navigate forward or backward along the personalized content stream 710 and is not necessarily limited to the current point. For instance, the human user may, via a remote control, scroll forward to see what other individual content items are available. The human user may also have the option of removing an individual content item from the personalized content stream 710 using, for instance, a drag and drop type motion. Similarly, the human user may add an individual content item to the personalized content stream 710 at a specified point.

On the bottom point of arrow 705 may be the options section 720 of the user interface screen 710. The options section 720 may include multiple options including, but not limited to, an “up next” option 730, a “you just saw” option 740, a “browse related content” option 750, an “if you liked this” option 760, and a “from your friends” option 770. The above labeled options are illustrative and not intended to limit the disclosure. Each of the options 730-770 may include selections within the option that are available to the human user.

The “up next” option 730 may provide information pertaining to the next individual content item in the personalized content stream 710. In this example, the next item is the movie “Hunt for Red October”. Within this option may be sub-options to skip to the next individual content item, play the next item now, or obtain more information on the item such as the release date, actors, rating information, etc. The embodiments are not limited in this context.

The “you just saw” option 740 may provide information pertaining to the individual content item that just completed. In this example, the individual content item that just completed was an episode of the TV show ‘Friends’. Specifically, it was episode 6 of season 2. Within this option may be sub-options to replay the episode, see the next episode in the series, replay the season (e.g., season 2 in this case), or play the series pilot episode. The embodiments are not limited in this context.

The “browse related content” option 750 may provide information pertaining to this episode directly. Within this option may be sub-options identifying the stars of the show. Selecting one of these sub-options such as the one labeled “Courteney Cox” may bring up a new user interface screen dedicated to video content or news associated with Courteney Cox. The embodiments are not limited in this context.

The “if you liked this” option 760 may provide information pertaining to similar shows. In this example, shows similar or otherwise pertaining to ‘Friends’ may be presented. Within this option may be sub-options to select the BBC version of Coupling, Family Ties, or a Saturday Night Live spoof of ‘Friends’. The embodiments are not limited in this context.

The “from your friends” option 770 may provide information pertaining to things the human user's friends think may be of interest. In this example, two friends have provided suggestions for the human user. These include a Youtube video from John D and the Conan O'Brien show from Susan. The embodiments are not limited in this context.

The embodiments described herein may replace the need for users to “channel surf’. As when using a Digital Video Recorder (DVR), the user may choose to fast-forward or rewind the current show. In contrast to the typical features of a DVR or broadcast TV, the user may choose to skip the show currently playing and advance to the next show in the cue to be presented. When a show ends (either naturally or because the user has skipped ahead), the user may be presented with a content selection screen 700. This screen may feature the content that may be coming next and other recommendations. A passive user who does nothing may simply be presented the next individual content item automatically. Content may be automatically added to the content stream based on the user profile and context. An active user may browse additional recommendations, including other content within the series just shown (e.g., the next episode, the season opener, the pilot), other content with the same actors, other recommended content (shows that others who watch this show like), or recommendations delivered from friends in the user's social network. The user may also be presented with a generic search capability in order to search for content he or she may be interested in watching immediately or at a later point in time. Users may get to the content selection screen at any time they wish to display the list of upcoming shows (the content stream) and/or make modifications to this list. The user may also see the content selection screen on a secondary device, such as a PC, tablet, or phone, without interrupting the content playback.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

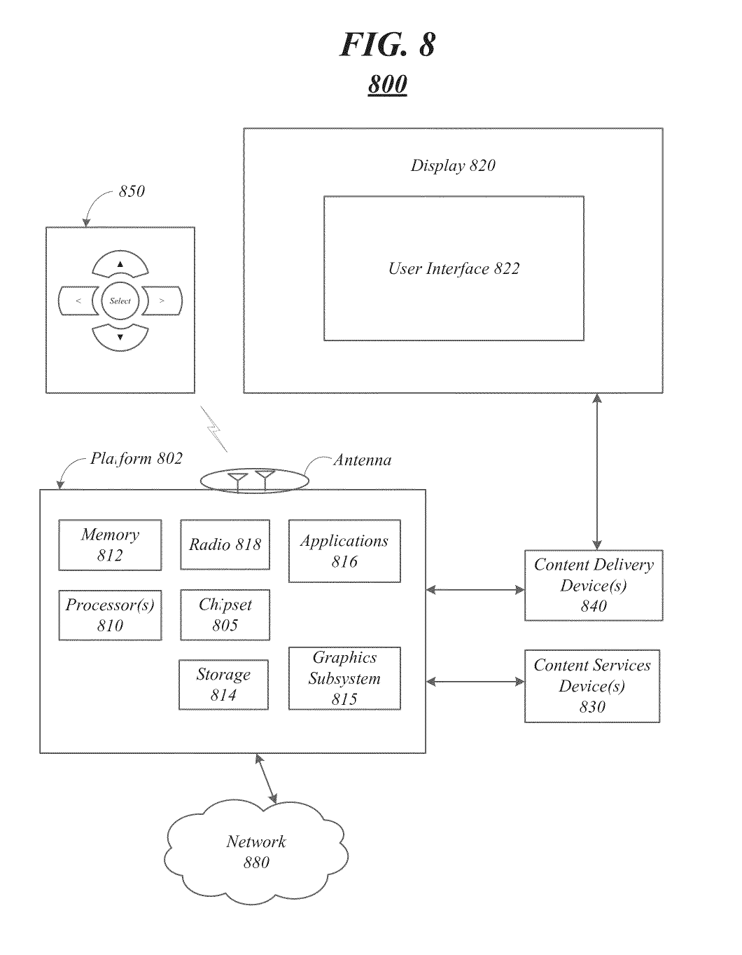

FIG. 8 illustrates an embodiment of a system 800 that may be suitable for implementing the content personalization embodiments of the disclosure. In embodiments, system 800 may be a system capable of personalizing content although system 800 is not limited to this context. For example, system 800 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 800 comprises a platform 802 coupled to a display 820. Platform 802 may receive content from a content device such as content services device(s) 830 or content delivery device(s) 840 or other similar content sources. A navigation controller 850 comprising one or more navigation features may be used to interact with, for example, platform 802 and/or display 820. Each of these components is described in more detail below.

In embodiments, platform 802 may comprise any combination of a chipset 805, processor(s) 810, memory 812, storage 814, graphics subsystem 815, applications 816 and/or radio 818. Chipset 805 may provide intercommunication among processor 810, memory 812, storage 814, graphics subsystem 815, applications 816 and/or radio 818. For example, chipset 805 may include a storage adapter (not depicted) capable of providing intercommunication with storage 814.

Processor(s) 810 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor(s) 810 may comprise dual-core processor(s), dual-core mobile processor(s), and so forth.

Memory 812 may be implemented as a volatile memory device such as, but not limited to, a Random Access Memory (RAM), Dynamic Random Access Memory (DRAM), or Static RAM (SRAM).

Storage 814 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 814 may comprise technology to increase the storage performance enhanced protection for valuable digital media when multiple hard drives are included, for example.

Graphics subsystem 815 may perform processing of images such as still or video for display. Graphics subsystem 815 may be a graphics processing unit (GPU) or a visual processing unit (VPU), for example. An analog or digital interface may be used to communicatively couple graphics subsystem 815 and display 820. For example, the interface may be any of a High-Definition Multimedia Interface, DisplayPort, wireless HDMI, and/or wireless HD compliant techniques. Graphics subsystem 815 could be integrated into processor 810 or chipset 805. Graphics subsystem 815 could be a stand-alone card communicatively coupled to chipset 805.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 818 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 818 may operate in accordance with one or more applicable standards in any version.

In embodiments, display 820 may comprise any television type monitor or display. Display 820 may comprise, for example, a computer display screen, touch screen display, video monitor, television-like device, and/or a television. Display 820 may be digital and/or analog. In embodiments, display 820 may be a holographic display. Also, display 820 may be a transparent surface that may receive a visual projection. Such projections may convey various forms of information, images, and/or objects. For example, such projections may be a visual overlay for a mobile augmented reality (MAR) application. Under the control of one or more software applications 816, platform 802 may display user interface 822 on display 820.

In embodiments, content services device(s) 830 may be hosted by any national, international and/or independent service and thus accessible to platform 802 via the Internet, for example. Content services device(s) 830 may be coupled to platform 802 and/or to display 820. Platform 802 and/or content services device(s) 830 may be coupled to a network 860 to communicate (e.g., send and/or receive) content to and from network 860. Content delivery device(s) 840 also may be coupled to platform 802 and/or to display 820.

In embodiments, content services device(s) 830 may comprise a cable television box, personal computer, network, telephone, Internet enabled devices or appliance capable of delivering digital information and/or content, and any other similar device capable of unidirectionally or bidirectionally communicating content between content providers and platform 802 and/display 820, via network 860 or directly. It will be appreciated that the content may be communicated unidirectionally and/or bidirectionally to and from any one of the components in system 800 and a content provider via network 860. Examples of content may include any content including, for example, video, music, medical and gaming information, and so forth.

Content services device(s) 830 receives content such as cable television programming including content, digital information, and/or other content. Examples of content providers may include any cable or satellite television or radio or Internet content providers. The provided examples are not meant to limit embodiments of the invention.

In embodiments, platform 802 may receive control signals from navigation controller 850 having one or more navigation features. The navigation features of controller 850 may be used to interact with user interface 822, for example. In embodiments, navigation controller 850 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 850 may be echoed on a display (e.g., display 820) by movements of a pointer, cursor, focus ring, or other visual indicators displayed on the display. For example, under the control of software applications 816, the navigation features located on navigation controller 850 may be mapped to virtual navigation features displayed on user interface 822, for example. In embodiments, controller 850 may not be a separate component but integrated into platform 802 and/or display 820. Embodiments, however, are not limited to the elements or in the context shown or described herein.

In embodiments, drivers (not shown) may comprise technology to enable users to instantly turn on and off platform 802 like a television with the touch of a button after initial boot-up, when enabled, for example. Program logic may allow platform 802 to stream content to media adaptors or other content services device(s) 830 or content delivery device(s) 840 when the platform is turned “off.” In addition, chip set 805 may comprise hardware and/or software support for 5.1 surround sound audio and/or high definition 8.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 800 may be integrated. For example, platform 802 and content services device(s) 830 may be integrated, or platform 802 and content delivery device(s) 840 may be integrated, or platform 802, content services device(s) 830, and content delivery device(s) 840 may be integrated, for example. In various embodiments, platform 802 and display 820 may be an integrated unit. Display 820 and content service device(s) 830 may be integrated, or display 820 and content delivery device(s) 840 may be integrated, for example. These examples are not meant to limit the invention.

In various embodiments, system 800 may be implemented as a wireless system, a wired system, or a combination of both. When implemented as a wireless system, system 800 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 800 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 802 may establish one or more logical or physical channels to communicate information. The information may include content and control information. Content may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route content through a system, or instruct a node to process the content in a predetermined manner. The embodiments, however, are not limited to the elements or in the context shown or described in FIG. 8.

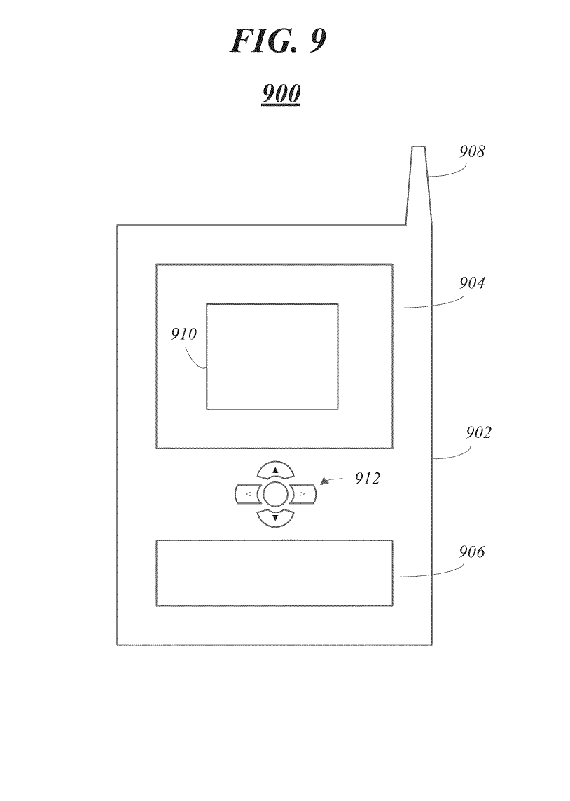

As described above, system 800 may be embodied in varying physical styles or form factors. FIG. 9 illustrates embodiments of a small form factor device 900 in which system 800 may be embodied. In embodiments, for example, device 900 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 9, device 900 may comprise a housing 902, a display 904, an input/output (I/O) device 906, and an antenna 908. Device 900 also may comprise navigation features 912. Display 904 may comprise any suitable display unit for displaying information appropriate for a mobile computing device. I/O device 906 may comprise any suitable I/O device for entering information into a mobile computing device. Examples for I/O device 906 may include an alphanumeric keyboard, a numeric keypad, a touch pad, input keys, buttons, switches, rocker switches, microphones, speakers, voice recognition device and software, and so forth. Information also may be entered into device 900 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus, comprising:
a storage component;
a communications component;
a processing component communicatively coupled to the storage component and communications component, the processing component comprising:
a personalization engine operative on the processing component to determine viewing preferences associated with a human user;
a contextual understanding component operative on the processing component to create a user profile based on the viewing preferences of the human user; and
a content aggregator component operative on the processing component to aggregate content from multiple sources into a personalized content stream based on the user profile.

2. The apparatus of claim 1, the communications component operative to forward the personalized content stream to an output device.

3. The apparatus of claim 1, the content aggregator component operative on the processing component to organize the personalized content stream into a series of individual content items.

4. The apparatus of claim 3, comprising:
a user interface component operative on the processing component to display a representation of the personalized content stream on an output device, the representation including a navigable presentation of the series of individual content items.

5. The apparatus of claim 4, the user interface component operative on the processing component to:
receive a control directive selecting an individual content item from the personalized content stream; and
display additional options pertaining to the selected individual content item on the output device.

6. The apparatus of claim 3, the personalization engine operative on the processing component to insert advertising content into the personalized content stream between or within the individual content items.

7. The apparatus of claim 1, the contextual understanding component operative on the processing component to:
receive input pertaining to past viewing behavior;
receive input pertaining to web-browsing topics of interest to the user;
mine calendar events related to topics of interest to the user; and
mine email data for topics of interest to the user.

8. The apparatus of claim 7, the contextual understanding component operative on the processing component to determine a contextual understanding of the human user based on at least one of the past viewing behavior input, the web-browsing input, the calendar events, and the email data.

9. The apparatus of claim 8, the personalization engine operative on the processing component to use the contextual understanding to determine the viewing preferences associated with the human user.

10. The apparatus of claim 9, the personalization engine operative on the processing component to search for content related to the viewing preferences associated with the human user.

11. The apparatus of claim 10, the personalization engine operative on the processing component to store the content related to the viewing preferences associated with the human user in the storage component.

12. The apparatus of claim 1, the personalization engine operative on the processing component to store the user profile in the storage component.

13. The apparatus of claim 12,
the contextual understanding component operative on the processing component to update the user profile periodically; and
the content aggregator component operative on the processing component to periodically re-aggregate the content based on the updated user profile into an updated personalized content stream.

14. The apparatus of claim 1, comprising a display.

15. A method, comprising:
determining viewing preferences associated with a human user;
creating a user profile based on the viewing preferences of the human user;
aggregating content from multiple sources into a personalized content stream comprised of a series of individual content items, the personalized content stream based on the user profile; and
displaying a representation of the personalized content stream on an output device, the representation including a navigable presentation of the series of individual content items.

16. The method of claim 15, comprising:
receiving a control directive selecting an individual content item from the personalized content stream; and
displaying additional options pertaining to the selected individual content item.

17. The method of claim 15, comprising inserting advertising content into the personalized content stream within or between the individual content items.

18. The method of claim 15, comprising:
receiving input pertaining to past viewing behavior;
receiving input pertaining to web-browsing topics of interest to the user;
mining calendar events related to topics of interest to the user; and
mining email data for topics of interest to the user.

19. The method of claim 18, comprising:
determining a contextual understanding of the human user based on at least one of the past viewing behavior input, the web-browsing input, the calendar events, and the email data; and
using the contextual understanding to determine the viewing preferences associated with the human user.

20. The method of claim 19, comprising:
searching for content related to the viewing preferences associated with the human user;
storing the content related to the viewing preferences associated with the human user; and
storing the user profile.

21. The method of claim 20, comprising:
updating the user profile periodically; and
periodically re-aggregating the content based on the updated user profile into an updated personalized content stream.

22. At least one computer-readable storage medium comprising instructions that, when executed, enable a system to:
determine viewing preferences associated with a human user;
create a user profile based on the viewing preferences of the human user; and
aggregate content from multiple sources into a personalized content stream based on the user profile.

23. The computer-readable storage medium of claim 22, comprising instructions that when executed enable a system to forward the personalized content stream to an output device.

24. The computer-readable storage medium of claim 22, comprising instructions that when executed enable a system to organize the personalized content stream into a series of individual content items.

25. The computer-readable storage medium of claim 24, comprising instructions that when executed enable a system to display a representation of the personalized content stream on an output device, the representation including a navigable presentation of the series of individual content items.

26. The computer-readable storage medium of claim 25, comprising instructions that when executed enable a system to:
receive a control directive selecting an individual content item from the personalized content stream; and
display additional options pertaining to the selected individual content item.

27. The computer-readable storage medium of claim 24, comprising instructions that when executed enable a system to insert advertising content into the personalized content stream within or between the individual content items.

28. The computer-readable storage medium of claim 22, comprising instructions that when executed enable a system to:
receive input pertaining to past viewing behavior;
receive input pertaining to web-browsing topics of interest to the user;
mine calendar events related to topics of interest to the user; and
mine email data for topics of interest to the user.

29. The computer-readable storage medium of claim 28, comprising instructions that when executed enable a system to determine a contextual understanding of the human user based on at least one of the past viewing behavior input, the web-browsing input, the calendar events, and the email data.

30. The computer-readable storage medium of claim 29, comprising instructions that when executed enable a system to use the contextual understanding to determine the viewing preferences associated with the human user.

31. The computer-readable storage medium of claim 30, comprising instructions that when executed enable a system to:
search for content related to the viewing preferences associated with the human user;
store the content related to the viewing preferences associated with the human user; and
store the user profile.

32. The computer-readable storage medium of claim 31, comprising instructions that when executed enable a system to:
update the user profile periodically; and
periodically re-aggregate the content based on the updated user profile into an updated personalized content stream.
